(19) United States
(12) Patent Application Publication
(10) Pub. No.: US 2018/0010697 A1
(43) Pub. Date: Jan. 11, 2018

(54) GATE VALVE AND SEATS FOR A GATE VALVE

(71) Applicant: CACTUS WELLHEAD, LLC, HOUSTON, TX (US)

(72) Inventor: GLENN C. PARKS, JR., CYPRESS, TX (US)

(73) Assignee: CACTUS WELLHEAD, LLC, HOUSTON, TX (US)

(21) Appl. No.: 15/605,599

(22) Filed: May 25, 2017

Related U.S. Application Data
(60) Provisional application No. 62/358,376, filed on Jul. 5, 2016.

(51) Int. Cl. F16K 3/02; F16K 25/04; F16K 31/50; E21B 43/26

(52) U.S. Cl. CPC F16K 3/0227; F16K 31/508; F16K 25/04; E21B 43/26

(57) ABSTRACT

A gate valve and a seat for a gate valve having a valve body, which may be used for hydrocarbon well fracturing operations with a fracturing fluid, or “frac fluid”, includes a seat pocket for receipt of the seat, which seat may include a tubular member having a seat end face, the seat end face includes two annular seals disposed in seat grooves, at least one of which is a half-dovetail groove.

### 1. RELATED APPLICATION

This application claims the benefit, and priority benefit, of U.S. Patent Application Ser. No. 62/358,376, filed Jul. 5, 2016, entitled “Gate Valve and Seats for a Gate Valve”.

### BACKGROUND OF THE INVENTION

### 2. Field of the Disclosure

This disclosure relates generally to the field of gate valves and seats for gate valves, and in particular gate valves for use in fracturing operations conducted in connection with wells for the production of hydrocarbons.

### 3. Description of the Related Art

In oilfield production operations, some wells may be stimulated to increase the production of hydrocarbons, such as oil and gas. Such techniques may include high-pressure, or hydraulic, fracturing of the well formation, known to the art as “fracing” a well formation. Generally, in this process a sand-bearing slurry or fracturing fluid, or “frac fluid”, is pumped down into the formation surrounding the wellbore at very high pressure. The sand particles, or proppant, of the frac fluid become embedded in small cracks and fissures in the formation, wedging them open and, thus, increasing the flow of produced fluid. Typically, the fluids used during fracturing are often very abrasive. Gate valves may be used in connection with the wellhead during fracturing operations, through which pass the sand-bearing slurry, or frac fluid, as well as other debris generated in connection with the fracturing operations.

### BRIEF SUMMARY

The following presents a simplified summary of the disclosed subject matter in order to provide a basic understanding of some aspects of the subject matter disclosed herein. This summary is not an exhaustive overview of the technology disclosed herein. It is not intended to identify key or critical elements of the invention or to delineate the scope of the invention. Its sole purpose is to present some concepts in a simplified form as a prelude to the more detailed description that is discussed later.

In one exemplary embodiment, a gate valve for a fluid may include: a gate valve for a fluid comprising a valve body having an internal valve cavity; first and second flow passageways extending through the valve body, each flow passageway having a longitudinal axis; a gate member disposed within the valve body and having an opening which may be moved into a fluid transmitting relationship with the first and second flow passageways; an annular recess in the valve body and disposed adjacent and around the first flow passageway, the annular recess having a first wall surface disposed substantially perpendicular to the longitudinal axis of the first flow passageway and a second wall surface disposed substantially parallel to the longitudinal axis of the first flow passageway; the annular recess forming a seat pocket for receipt of a seat; the seat is disposed between the gate member and the valve body, the seat being a tubular member and having first and second ends and an inner and an outer wall surface extending between the first and second ends, the first end of the seat is disposed within the seat pocket and the second end of the seat is disposed adjacent the gate member, the first end of the elongate tubular member having a seat end face; the seat end face includes first and second concentrically disposed seal grooves, with an O-ring seal disposed in each of the first and second seal grooves; and at least one of the seal grooves is an annular half-dovetail groove in the seat end face.

In another exemplary embodiment, a seat for a gate valve having a gate member, a gate valve body having an internal valve cavity, first and second flow passageways extending through the valve body, and a seat pocket in the valve body for receipt of seat, may include a tubular member having first and second ends and an inner and an outer wall surface extending between the first and second ends, the first end of the seat adapted to be disposed within the seat pocket and the second end of the seat is adapted to be disposed adjacent the gate member, the first end of the tubular member having a seat end face; the seat end face includes first and second concentrically disposed seal grooves, with an O-ring seal disposed in each of the first and second seal grooves; and at least one of the seal grooves is an annular half-dovetail groove in the seat end face.

### BRIEF DESCRIPTION OF THE DRAWING

The present gate valve and seats for a gate valve may be understood by reference to the following description taken in conjunction with the accompanying drawing, in which:

FIG. 1 is a front view of a gate valve in accordance with an exemplary embodiment of the present invention, with a cutaway portion A showing a portion of the interior of the gate valve;

FIG. 2 is an enlarged partial cross-sectional view of the cutaway portion A of the gate valve of FIG. 1;

FIG. 3 is an enlarged partial cross-sectional view of a seat of the gate valve of FIG. 2 denoted by the dotted circle 3 of FIG. 2;

FIG. 4 is a perspective view of an exemplary embodiment of the seat of FIG. 3;

FIG. 5 is an enlarged partial cross-sectional view of a seat of the gate valve of FIG. 3 denoted by the dotted circle 5 of FIG. 3; and

FIG. 6 is a perspective view of an exemplary embodiment of the seat of FIG. 5.

While certain embodiments of the present gate valve and seats for a gate valve will be described in connection with the present exemplary embodiments shown herein, it will be understood that it is not intended to limit the invention to those embodiments. On the contrary, it is intended to cover all alternatives, modifications, and equivalents, as may be included within the spirit and scope of the invention as defined by the appended claims. In the drawing figures, which are not to scale, the same reference numerals are used throughout the description and in the drawing figures for components and elements having the same structure, and primed reference numerals are used for components and elements having a similar function and construction to those components and elements having the same unprimed reference numerals.

### DETAILED DESCRIPTION OF THE EXEMPLARY EMBODIMENTS

It should be understood that, although an illustrative implementation of one or more exemplary embodiments are provided below, the various specific exemplary embodiments may be implemented using any number of techniques known by persons of ordinary skill in the art. The disclosure should in no way be limited to the exemplary embodiments, drawings, and/or techniques illustrated below, including the exemplary designs and implementations illustrated and described herein. Furthermore, the disclosure may be modified within the scope of the appended claims along with their full scope of equivalents.

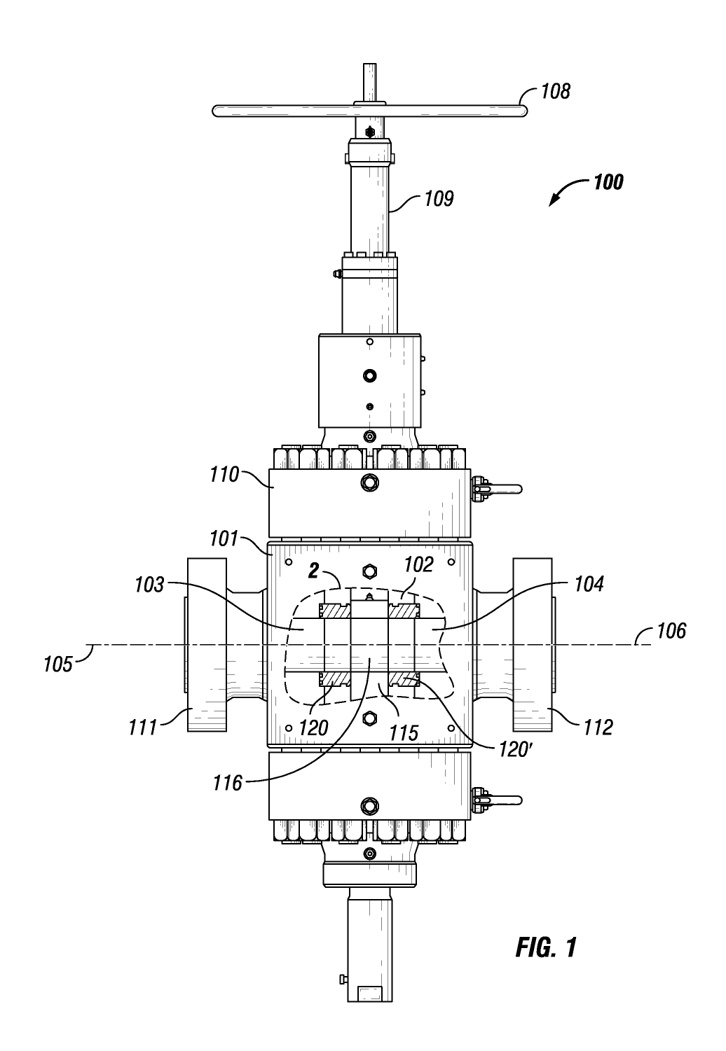

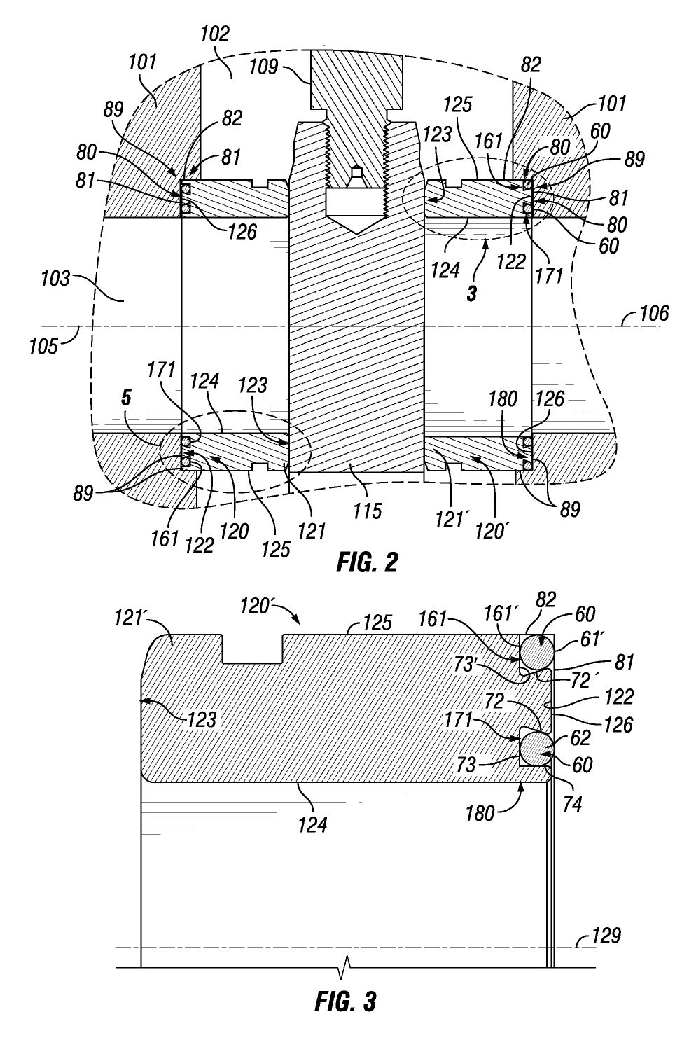

With reference to FIGS. 1-2, a gate valve 100 in accordance with an illustrative embodiment is shown to generally include a valve body 101 having an internal valve cavity 102, first and second passageways 103, 104 extending through the valve body 101, with each passageway 103, 104 having a longitudinal axis 105, 106. Preferably, as shown in FIG. 1, the longitudinal axes 105, 106 are coplanar and coincide with each other. As known in the art, gate valve 100 may be provided with a hand wheel 108, or another conventional actuation device, to move a valve stem 109 upwardly or downwardly within valve cavity 102. Gate valve 100 also preferably includes a conventional bonnet 110 that seals about valve stem 109 and seals off valve cavity 102 at the top of valve body 101. Valve 100 may include conventional flanged connectors 111, 112, and sections of pipe (not shown) may be connected to the flanged connectors 111, 112 in a conventional manner. A fluid, such as a sand-bearing slurry or fracturing fluid or “frac fluid”, or any other conventional fluid, may be pumped through the gate valve 100 to flow through the valve body 101 and through the first and second passageways, or flow passageways, 103, 104.

Still with reference to FIGS. 1-2, a gate member 115, associated with valve stem 109, is disposed within the valve body 101, and is movable within valve body 101 by movement of valve stem 109 caused by rotating hand wheel 108, or by any other actuation device. Gate member 115 has an opening 116, and upon movement of valve stem 109, the opening 116 of gate member 115 may be moved into, and out of, a fluid transmitting relationship with the first and second flow passageways 103, 104, in a conventional manner. In FIG. 1, gate valve 100 is shown in its fully open, fluid transmitting relationship, with opening 116 in alignment with the first and second passageways 103, 104. In FIG. 2, gate valve 100 is shown in its closed configuration, or fluid non-transmitting relationship, with the gate member 115 having been lowered so that gate member 115 blocks fluid flow through gate valve 100. Seats, or valve seats, 120, 120′ are disposed in seat pockets 89 within valve cavity 102 between gate member 115 and each of the passageways 103, 104, whereby when gate member is in its open position, as shown in FIG. 1, fluid may flow through the seats 120, 120′, the opening 116 in gate member 115, and through the first and second passageways 103, 104.

Gate valve 100 is illustrated as a bi-directional gate valve, in which fluid may flow through gate valve 100 either in a direction from left to right, or right to left as viewed in connection with FIGS. 1-2. If gate valve 100 is used as a bi-directional gate valve, the seats 120, 120′ would preferably be of the same construction. Optionally and alternatively, if gate valve 100 is only to be utilized for fluid flow in a direction from the left to the right, when viewed in connection with FIGS. 1-2, with the fluid entering the first flow passageway 103 and passing to the right toward the second flow passageway 104, seat 120 adjacent the first flow passageway 103, optionally and if desired, could have a different seat construction. Optionally and if desired, the location of seats 120, 120′ could be reversed from their locations shown in FIG. 2, whereby seat 120′ could be disposed adjacent first flow passageway 103, and seat 120 could be disposed adjacent the second flow passageway 104. Optionally and alternatively, two seats 120 could be utilized in gate valve 100, or two seats 120′ could be utilized in gate valve 100. As shown in FIG. 2, the seats 120, 120′ include seals, as will be hereinafter described in greater detail, which provide sealing between the seats 120, 120′ and the valve body 101.

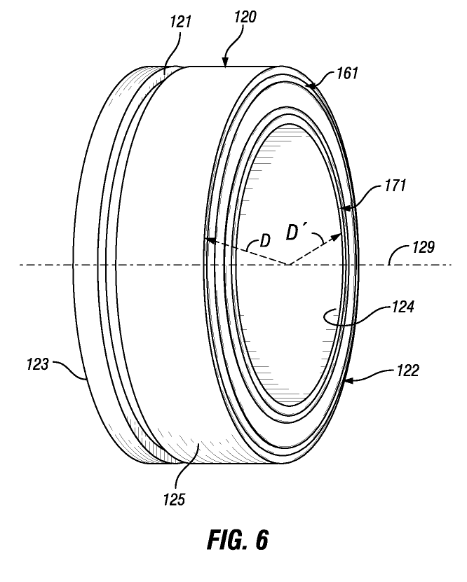

With reference to FIGS. 2-6, the seats, or valve seats, 120, 120′ will be described in greater detail. Valve body 101 is provided with annular recesses 80 which are disposed adjacent and around the first flow passageway, or first passageway, 103 and the second flow passageway, or second passageway, 104. The annular recesses 80 have: first wall surfaces 81 disposed substantially perpendicular to the longitudinal axes 105, 106 of the first and second flow passageways 103, 104; and second wall surfaces 82 disposed substantially parallel to the longitudinal axes 105, 106 of the first and second passageways 103, 104. The annular recesses 80 form the seat pockets 89 of sufficient depth for receipt of an end portion 180 of seats 120, 120′.

As shown in FIGS. 2-6, each seat 120, 120′ is preferably a tubular member 121, 121′ having a longitudinal axis 129, first and second ends 122, 123, and an inner wall surface 124 and an outer wall surface 125 extending between the first and second ends 122, 123. The first end 122 of each tubular member 121, 121′ is disposed adjacent one of the flow passageways 103, 104, and the second end 123 is disposed adjacent the gate member 115. The first end 122 of each tubular member 121, 121′ has a substantially smooth, seat end face 126, which may be provided in a conventional manner as by machining seat end face 126. The longitudinal axis 129 of each tubular member 121 preferably coincides with the longitudinal axis 105 of the first passageway 103 and the longitudinal axis 106 of the second passageway 104. As shown in FIG. 2, the seats 120, 120′ are disposed in each seat pocket 89 in a sealing relationship between gate member 115 and the valve body 101, as will be hereinafter described.

Still with reference to FIGS. 2-6, the seats 120, 120′ will be described in greater detail. Each seat end face 126 includes two concentrically disposed annular seals 60. Annular seals 60 are disposed in concentrically disposed annular seal grooves 161, 171, formed in the seat end faces 126. The annular seals 60 seal and grooves 161, 171 lie in planes which are perpendicular to the longitudinal axis 129 of the seats 120, 120′ and to the inner and outer wall surfaces 124, 125 of the seats. The seats 120, 120′ are disposed in the seat pockets 89 with the seals 60 in a sealing relationship between the seat end faces 126 and the valve body 101. As shown in FIG. 2, optionally and preferably the end portions 180 of seats 120, 120′, or a portion of the outer wall surfaces 125 of seats 120, 120′, are disposed adjacent the second wall surfaces 82 of annular recesses 80 which form seat pockets 89 The end portions 180 of seats 120, 120′ are slidingly received, or slip fit, within seat pockets 89.

The annular seals 60 may be of any suitable construction to provide the desired sealing relationship: between seats 120, 120′, or the seat end faces 126, and the valve body 101; and between the first wall surfaces 81 of annular recesses 80 and the seat end faces 126. Preferably, annular seals 60 are O-ring seals. Annular seals 60 may be made of any material having the requisite strength and sealing characteristics to function in a gate valve having frac fluid passing therethrough.

Seal groove, or outer diameter groove, 161 and seal groove, or inner diameter groove, 171, each have a diameter D, D′, and the diameter D of groove 161 is larger than the diameter D′ of the groove 171. Each seal groove 161, 171 receives, or contains, an annular seal 60, or outer diameter seal 61 and inner diameter seal 62. Grooves 161, 171, may have any suitable cross-sectional configuration which is capable of receiving the annular seals 60, but preferably, at least one of the annular seal grooves 161, 171, is an annular half-dovetail groove formed in seat end face 126, which groove has a half-dovetail cross-sectional configuration as shown in FIGS. 3 and 5. Preferably the annular grooves, or inner diameter seal grooves, 171 of seals 120, 120′, are annular half-dovetail grooves having a half-dovetail cross-sectional configuration in the seat end face 126. The sloping inner wall surface, or side wall surface, 72 of annular grooves 171 in combination with bottom wall 73 and side wall surface 74 of grooves 171 retain, or contain, annular seals 60 within grooves 171, after the seals 60 have been disposed within the grooves 171, as by pressing the seal 60 into the grooves 171. As shown in FIG. 5, seat 120 may also have seal groove, or outer diameter groove, 161 provided with the same cross-sectional configuration as groove 171. The annular half-dovetail grooves 161, 171 of FIG. 5 may be considered “closed” grooves, as the three walls 72, 73, 74 retain the seal 160 within grooves 161, 171.

As seen in FIGS. 2 and 5, when the end portion 180 of seat 120 is slidingly received, or slip fit, within its mating seat pocket 89, which includes wall surface 81 of annular recess 80, the seals 60, or seals 61, 62, retained, or contained, within, grooves 161, 171 by side walls 72, 74, and bottom wall 73, seal against wall surface 81 of the seat pocket 89.

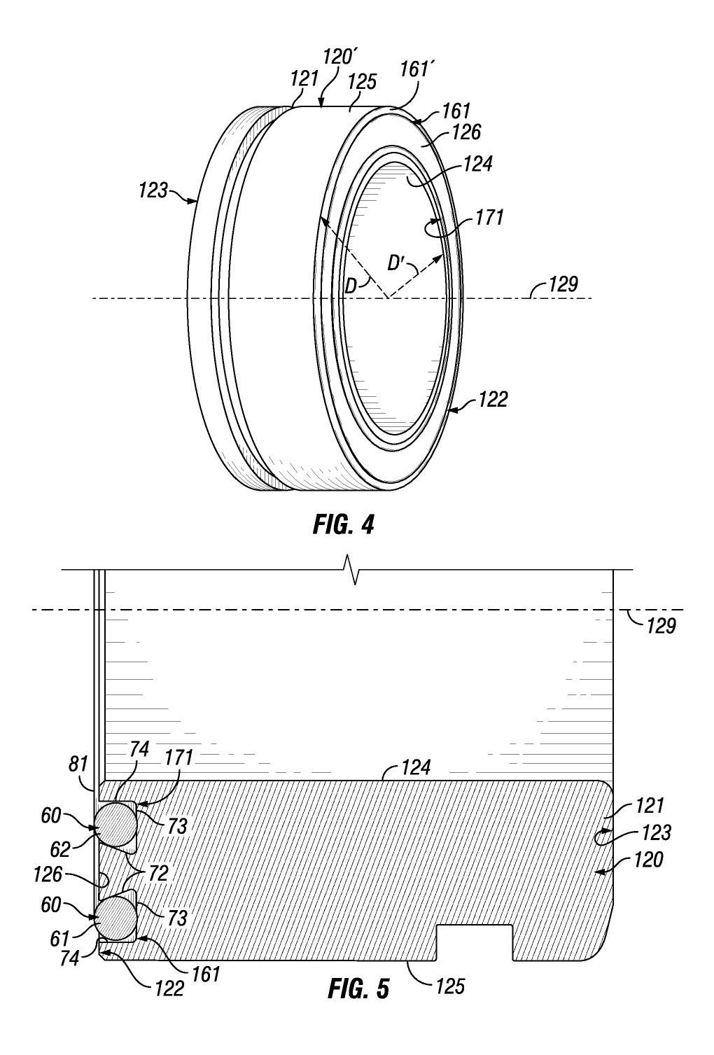

With reference to FIGS. 3 and 4, it is seen that seat 120′ also has an inner diameter groove 171 having a closed half-dovetail cross-sectional configuration as described in connection with FIG. 5. Seal 120′ is optionally or preferably provided with a groove, or outer diameter, groove 161′ which includes a sloping side wall 72′, like sloping side wall 72 of annular groove 171, and a bottom wall 73′, like bottom wall 73 in groove 171, but the outer diameter groove 161′ of seat 120′ does not include another side wall like side wall 74 of groove 171. Groove 161′ of FIG. 3 may be considered to be an “open” groove, as it only has a side wall 72′ and bottom wall 73′. Seal 60, or seal 61′, disposed within the open half-dovetail groove 161′ of seat 120′ is contained by the sidewall 72′, and bottom wall 73′ of groove 161′ and the wall surfaces 81 and 82 of annular recess 80 which form the seat pocket 89 as shown in FIGS. 2 and 3. Thus, when seat 120′ is slidingly received within its corresponding seat pocket 89, seal 60, or seal 61′, seals against side wall 72′, and bottom wall 73′ of groove 161′ and the wall surfaces 81 and 82 of annular recess 80. Seal 60, or seal 62, in seal groove, or inner diameter, groove 171 of seat 120′ is contained by sloping side wall 72, sidewall 74 and bottom wall 73 of groove 171, and seal 60 seals against the wall surface 81 of annular recess 80 which forms seat pocket 89.

Optionally and alternatively, the seal grooves 171 of seat 120′ and the seal grooves 161, 171 of seat 120 could be full dovetail grooves, each with a bottom wall and two sloping side walls. Optionally and alternatively a full dovetail groove could be substituted for any of the seal grooves 171 of seat 120′ or the seal grooves 161, 171 of seat 120.

The use of two annular seals 60 in the seat end face 126 of seats 120, 120′, provides a loading force, which keeps the gate member 115 and seats 120, 120′ engaged in a sealing relationship with the valve body 101 to provide the desired pressure sealing within valve body 101, during flow of frac fluid through gate valve 100. Additionally, the two seal grooves 161, 171, serve as isolation barriers keeping frac proppant, or the fine particles contained within the frac fluid, from packing behind the seats in the seat pocket 89. Thus, the seat pocket wall surfaces 81, 82 are protected from erosion and corrosion damage and are believed to have a longer life span in gate valve 100.

At least one embodiment is disclosed and variations, combinations, and/or modifications of the embodiment(s) and/or features of the embodiment(s) made by a person having ordinary skill in the art are within the scope of the disclosure. Alternative embodiments that result from combining, integrating, and/or omitting features of the embodiment(s) are also within the scope of the disclosure. When numerical ranges or limitations are expressly stated, such express ranges or limitations may be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). The use of the term “about” means±10% of the subsequent number, unless otherwise stated.

Use of the term “optionally” with respect to any element of a claim means that the element is required, or alternatively, the element is not required, both alternatives being within the scope of the claim. Use of broader terms such as comprises, includes, and having may be understood to provide support for narrower terms such as consisting of, consisting essentially of, and comprised substantially of. Accordingly, the scope of protection is not limited by the description set out above, but is defined by the claims that follow, that scope including all equivalents of the subject matter of the claims. Each and every claim is incorporated as further disclosure into the specification and the claims are embodiment(s) of the present disclosure.

While several exemplary embodiments have been provided in the present disclosure, it may be understood that the disclosed embodiments might be embodied in many other specific forms without departing from the spirit or scope of the present disclosure and the appended claims. The present examples are to be considered as illustrative and not restrictive, and the intention is not to be limited to the details given herein. For example, the various elements or components may be combined or integrated in another system or certain features may be omitted, or not implemented.

In addition, the various exemplary embodiments described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and may be made without departing from the spirit and scope disclosed herein.

I claim:

1. A gate valve for a fluid comprising:
a valve body having an internal valve cavity;
first and second flow passageways extending through the valve body, each flow passageway having a longitudinal axis;
a gate member disposed within the valve body and having an opening which may be moved into a fluid transmitting relationship with the first and second flow passageways;
an annular recess in the valve body and disposed adjacent and around the first flow passageway, the annular recess having a first wall surface disposed substantially perpendicular to the longitudinal axis of the first flow passageway and a second wall surface disposed substantially parallel to the longitudinal axis of the first flow passageway;
the annular recess forming a seat pocket for receipt of a seat;
the seat is disposed between the gate member and the valve body, the seat being a tubular member and having first and second ends and an inner and an outer wall surface extending between the first and second ends, the first end of the seat is disposed within the seat pocket and the second end of the seat is disposed adjacent the gate member, the first end of the elongate tubular member having a seat end face;
the seat end face includes first and second concentrically disposed seal grooves, with an O-ring seal disposed in each of the first and second seal grooves; and
at least one of the seal grooves is an annular half-dovetail groove in the seat end face.

2. The gate valve of claim 1, wherein the first and second seal grooves are annular half-dovetail grooves in the seat end face.

3. The gate valve of claim 1, wherein the first and second concentrically disposed seal grooves each have a diameter, and the diameter of the first seal groove is larger than the diameter of the second seal groove, and the second annular seal groove is an annular half-dovetail groove in the seat end face.

4. The gate valve of claim 1, wherein at least one of the annular seal grooves is an open annular half-dovetail groove in the seat surface.

5. The gate valve of claim 1, wherein the first and second concentrically disposed seal grooves each have a diameter, and the diameter of the first seal groove is larger than the diameter of the second seal groove and the first annular seal groove is an open annular half-dovetail groove in the seat surface.

6. A seat for a gate valve having a gate member, a gate valve body having an internal valve cavity, first and second flow passageways extending through the valve body, and a seat pocket in the valve body for receipt of seat and comprising:
a tubular member having first and second ends and an inner and an outer wall surface extending between the first and second ends, the first end of the seat adapted to be disposed within the seat pocket and the second end of the seat is adapted to be disposed adjacent the gate member, the first end of the tubular member having a seat end face;
the seat end face includes first and second concentrically disposed seal grooves, with an O-ring seal disposed in each of the first and second seal grooves; and
at least one of the seal grooves is an annular half-dovetail groove in the seat end face.

7. The seat valve of claim 6, wherein the first and second seal grooves are annular half-dovetail grooves in the seat end face.

8. The seat of claim 6, wherein the first and second concentrically disposed seal grooves each have a diameter, and the diameter of the first seal groove is larger than the diameter of the second seal groove, and the second annular seal groove is an annular half-dovetail groove in the seat end face.

9. The seat of claim 6, wherein at least one of the annular seal grooves is an open annular half-dovetail groove in the seat surface.

10. The seat of claim 6, wherein the first and second concentrically disposed seal grooves each have a diameter, and the diameter of the first seal groove is larger than the diameter of the second seal groove and the first annular seal groove is an open annular half-dovetail groove in the seat surface.
